(19) United States
(12) Patent Application Publication
(10) Pub. No.: US 2024/0288832 A1
(43) Pub. Date: Aug. 29, 2024

(54) TIME MEASURING DEVICE, DISTANCE MEASURING DEVICE, AND OPTICAL SENSOR DEVICE

(71) Applicant: Sharp Semiconductor Innovation Corporation, Tenri City (JP)

(72) Inventors: Takayuki SHIMIZU, Tenri city (JP); Takahiro INOUE, Tenri City (JP); HIDEKI SATO, Tenri City (JP); Tetsuro IKEDA, Tenri City (JP); RYUHJI ARIMURA, Tenri City (JP)

(21) Appl. No.: 18/436,139

(22) Filed: Feb. 8, 2024

(30) Foreign Application Priority Data
Feb. 28, 2023 (JP) 2023-030179

(51) Int. Cl. G04F 10/04; G01S 7/481; G01S 7/4915; G01S 17/32; G04F 10/00

(52) U.S. Cl. CPC G04F 10/04; G01S 7/4816; G01S 7/4915; G01S 17/32; G04F 10/005

(57) ABSTRACT

A time measuring device comprises a signal generating circuit configured to generate a plurality of reference signals in an equivalent cycle with different phases; a first counter configured to output a fine count value, using a plurality of first pulse signals obtained from the plurality of reference signals; a second counter configured to output a coarse count value, using a plurality of second pulse signals obtained from the plurality of reference signals and having frequencies lower than frequencies of the plurality of first pulse signals; and a control unit configured to determine whether to correct the coarse count value in accordance with the fine count value and the coarse count value latched with a latch signal, and, if the coarse count value needs to be corrected, configured to calculate a bin number, using the fine count value and a coarse correction value obtained by correcting the coarse count value.

### CROSS-REFERENCE TO RELATED APPLICATION

The present application claims priority from Japanese Application JP2023-030179, the content of which is hereby incorporated by reference into this application.

### BACKGROUND

### Field

The present disclosure relates to a time measuring device, a distance measuring device, and an optical sensor device.

### Background Art

Japanese Unexamined Patent Application Publication No. 2019-078690 discloses a time measuring device that causes two time-to-digital converters (TDCs) to alternately operate to detect a time of one event for one light emission cycle.

### SUMMARY

There is a demand for time measuring devices capable of measuring time more quickly.

A time measuring device according to an aspect of the present disclosure includes: a signal generating circuit generating a plurality of reference signals in an equivalent cycle with different phases; a first counter outputting a fine count value, using a plurality of first pulse signals obtained from the plurality of reference signals; a second counter outputting a coarse count value, using a plurality of second pulse signals obtained from the plurality of reference signals and having frequencies lower than frequencies of the plurality of first pulse signals; and a control unit determining whether to correct the coarse count value in accordance with the fine count value and the coarse count value latched with a latch signal, and, if the coarse count value needs to be corrected, configured to calculate a bin number, using the fine count value and a coarse correction value obtained by correcting the coarse count value.

An aspect of the present disclosure makes it possible to measure time more quickly.

### BRIEF DESCRIPTION OF THE DRAWINGS

FIG. 1 is a block diagram illustrating a configuration of a time measuring device according to the embodiments;

FIG. 2 is a timing diagram showing an operation of the time measuring device according to the embodiments;

FIG. 3 is a diagram showing a relationship between second pulse signals, and gray codes and binary codes of coarse count values;

FIG. 4 is a diagram showing a relationship between second pulse signals, and gray codes and binary codes of coarse count values;

FIG. 5 is a table showing a relationship between gray codes and binary codes of fine count values;

FIG. 6 is a flowchart showing an example of how to calculate a BIN number;

FIG. 7 is a diagram illustrating an example of how to calculate a BIN number;

FIG. 8 is a diagram illustrating an example of how to calculate a BIN number;

FIG. 9 is a diagram illustrating an example of how to calculate a BIN number;

FIG. 10 is a diagram illustrating an example of how to calculate a BIN number;

FIG. 11 is a diagram illustrating an example of how to calculate a BIN number;

FIG. 12 is a diagram showing correspondence between gray codes and fine count values output from a first counter;

FIG. 13 is a table for associating missing (gray) codes with fine count values;

FIG. 14 is a block diagram illustrating a configuration of a time measuring device having a table;

FIG. 15 is a block diagram illustrating a configuration of the time measuring device according to the embodiments;

FIG. 16 is a timing diagram showing an operation of the time measuring device according to the embodiments;

FIG. 17 is a histogram generated by a time calculating unit;

FIG. 18 is a block diagram illustrating a configuration of a distance measuring device according to the embodiments;

FIG. 19 is a schematic cross-sectional view of a configuration of an optical sensor device according to the embodiments;

FIG. 20 is a block diagram illustrating a configuration of the optical sensor device according to the embodiments;

FIG. 21 is a block diagram illustrating a configuration of the optical sensor device according to the embodiments; and

FIG. 22 is a block diagram illustrating a configuration of a time measuring device according to the embodiments.

### DESCRIPTION OF EMBODIMENTS

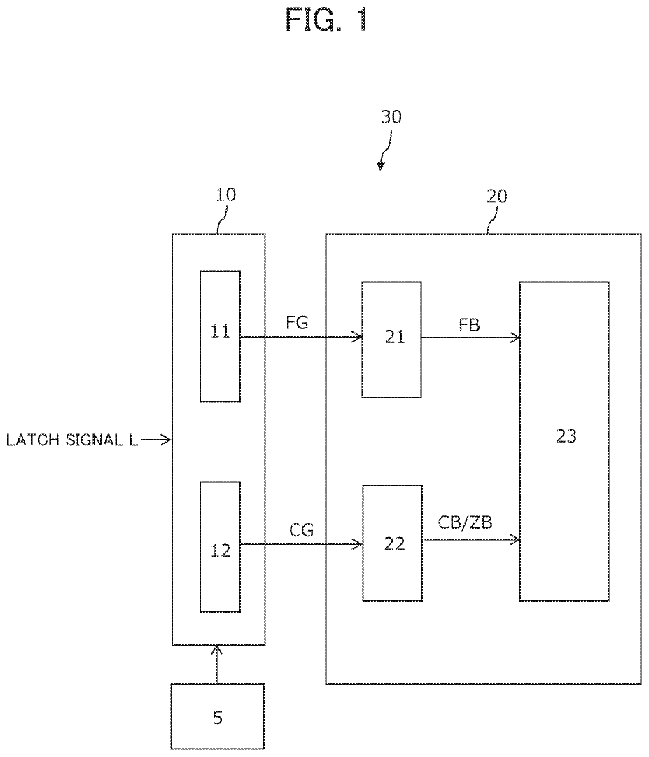

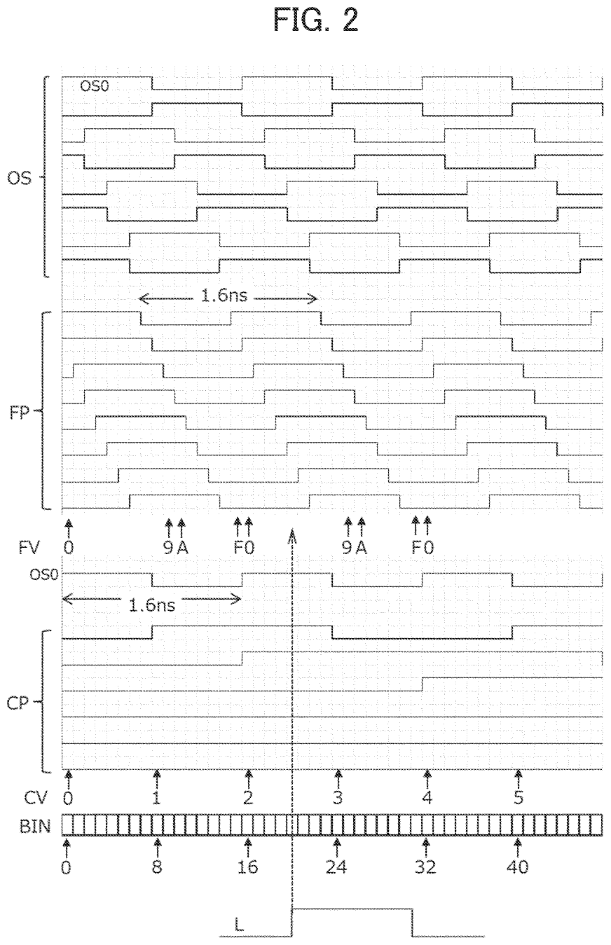

FIG. 1 is a block diagram illustrating a configuration of a time measuring device according to the embodiments. FIG. 2 is a timing diagram showing an operation of the time measuring device according to the embodiments. As illustrated in FIGS. 1 and 2, a time measuring device 30 according to the embodiments includes: a signal generating circuit 5 that generates a plurality of reference signals OS in an equivalent cycle with different phases; a time-to-digital converter 10 (TDC 10); and a control unit 20.

The TDC 10 includes: a first counter 11 that outputs a fine count value FV, using a plurality of first pulse signals FP obtained from a plurality of reference signals OS; and a second counter 12 that outputs a coarse count value CV, using a plurality of second pulse signals CP obtained from the plurality of reference signals OS and having frequencies lower than frequencies of the plurality of first pulse signals FP. The plurality of first pulse signals FP are, for example, 8-phase signals, and the plurality of second pulse signals CP are, for example, 6-phase signals. Hereinafter, the first counter 11 and the second counter 12 may be respectively referred to as a FINE counter and a COARSE counter.

The first counter 11 outputs the fine count value FV in a gray code. The second counter 12 outputs the coarse count value CV in a gray code. A count-up interval of the second counter 12 is longer than a count-up interval of the first counter 11.

The control unit 20 determines whether to correct the coarse count value CV in accordance with the fine count value FV and the coarse count value CV latched with a latch signal L. If the coarse count value needs to be corrected, the control unit 20 calculates a bin number BIN, using the fine count value FV and a coarse correction value CZ obtained by correcting the coarse count value CV. Note that the coarse count value CV may be, but not limited to, a coarse count value CV latched within plus or minus 4 TR since the fine count value FV is latched. Note that 4 TR means four times the minimum temporal resolution TR (e.g., 0.1 ns) of the TDC 10. In the case of FIG. 2, the latched fine count value FV is FV=4, the coarse count value CV is CV=2, the coarse count value CV does not have to be corrected, and the bin number BIN is BIN=20. One cycle (1.6 ns) of the reference signal OS corresponds to a 16 bin number. Hence, BIN=20 is 2.0 [ns].

The control unit 20 includes: a first code-converting unit 21 that converts a gray code FG (a fine count value) from the first counter 11 into a binary code FB; a second code-converting unit 22 that converts a gray code CG (a coarse count value) from the second counter 12 into a binary code CB and generates, as necessary, a binary code ZB serving as a coarse correction value; and a time calculating unit 23 that calculates time in accordance with the binary code FB from the first code-converting unit 21 and the binary code CB/ZB from the second code-converting unit 22.

Each of the first code-converting unit 21, the second code-converting unit 22, and the time calculating unit 23 may be a functional block. For example, in the control unit 20 including a processor and a memory, the processor may cooperate with the memory to execute a time measuring program, and implement functions of the functional blocks. The time measuring program may be stored in the memory of the control unit 20 or in an external storage device.

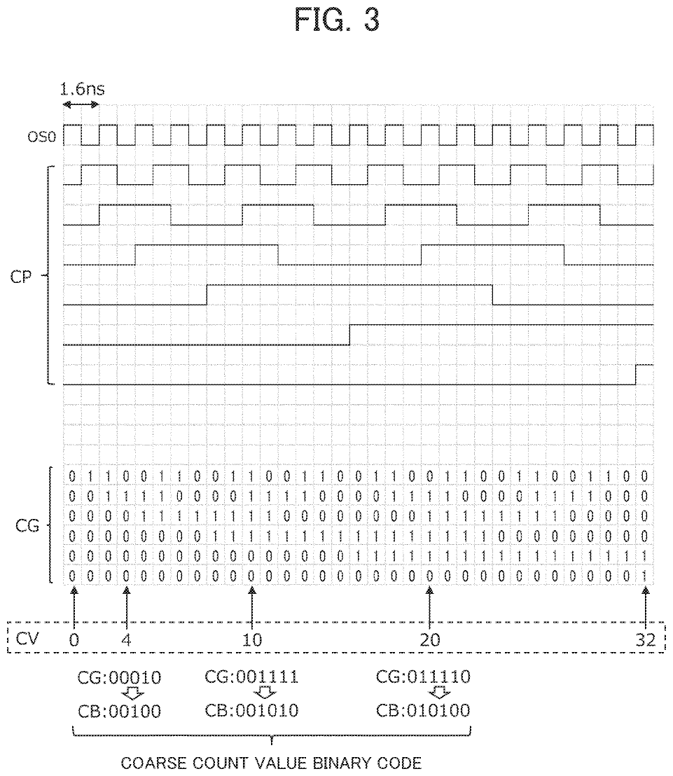

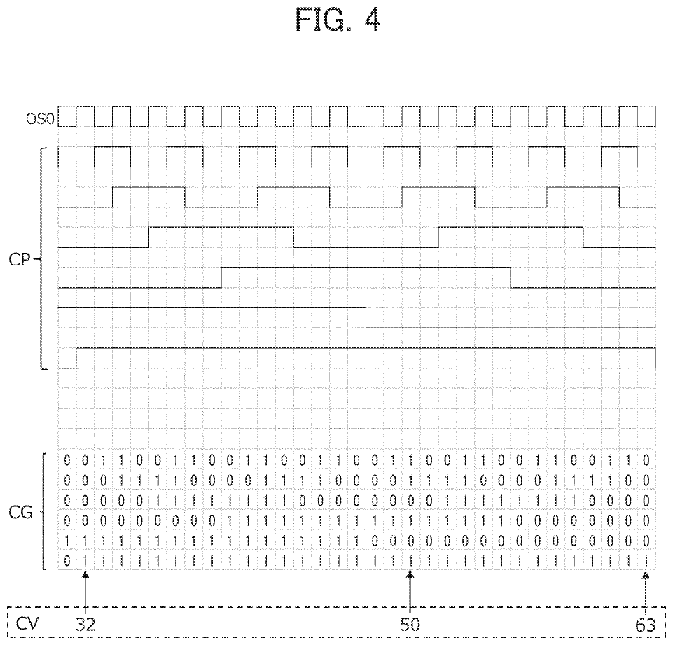

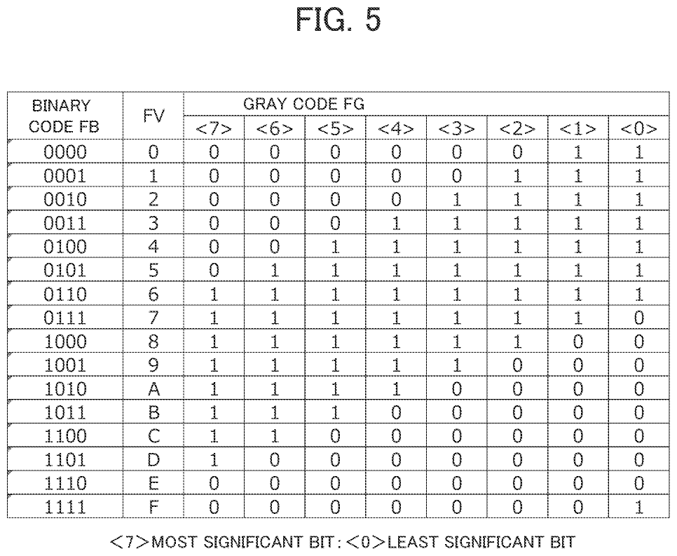

FIGS. 3 and 4 are diagrams showing a relationship between second pulse signals, and gray codes and binary codes of coarse count values. FIG. 5 is a table showing a relationship between gray codes and binary codes of fine count values.

As illustrated in FIGS. 3 and 4, where M and N are natural numbers of M<N, the first counter 11 periodically outputs M fine count values FV (e.g., if M=16, 16 fine count values of 0 to 9 and A to F), and the second counter 12 periodically outputs N coarse count values CV (e.g., if N=64, coarse count values of 0 to 63).

As illustrated in FIG. 2, a count interval of the first counter 11 may be 1/M of a cycle of the plurality of reference signals OS. The count interval of the first counter 11 may be 1.0 (nanosecond) or less.

The signal generating circuit 5 may be a ring oscillator. The first counter 11 may detect a phase of the ring oscillator to perform counting. The second counter 12 may detect oscillation counts of the ring oscillator to perform counting.

As illustrated in FIGS. 3 to 5, the gray code FG of the fine count value may be greater in bit number than the gray code CG of the coarse count value. For example, the gray code FG may have 8 bits and the gray code CG may have 6 bits.

As illustrated in FIGS. 3 to 5, if relationships of M=2^{X} and N=2^{Y} hold, the first code-converting unit 21 converts the fine count value into a binary code FB having X bits (e.g., X=4 bits), and the second code-converting unit 22 converts the coarse count value into a binary code CB having Y bits (e.g., Y=6 bits).

The second code-converting unit 22 determines that the coarse count value CV is not required to be corrected if a most significant bit of the binary code FB of the fine count value is equivalent to a least significant bit of the binary code CB of the coarse count value, and that the coarse count value CV is required be corrected if the most significant bit of the binary code FB of the fine count value is different from the least significant bit of the binary code CB of the coarse count value.

When the most significant bit of the binary code FB of the fine count value is different from the least significant bit of the binary code CB of the coarse count value, the second code-converting unit 22 sets a value adjacent to the coarse count value CV to the coarse correction value CZ, and matches the least significant bit of the binary code CB of the coarse count value to the most significant bit of the binary code FB of the fine count value. That is, the difference between the coarse count value CV and the coarse correction value CZ is 1.

When the coarse count value CV is not corrected, the time calculating unit 23 combines a higher-order (Y−1) bit of the binary code CB of the coarse count value with a higher order of the binary code FB of the fine count value, and calculates a bin number BIN corresponding to a (X+Y−1)-bit binary code obtained by the combination.

When the coarse count value CV is corrected, the time calculating unit 23 combines a higher-order (Y−1) bit of a binary code ZB of the coarse correction value with the higher order of the binary code FB of the fine count value, and calculates a bin number BIN corresponding to a (X+Y−1)-bit binary code obtained by the combination.

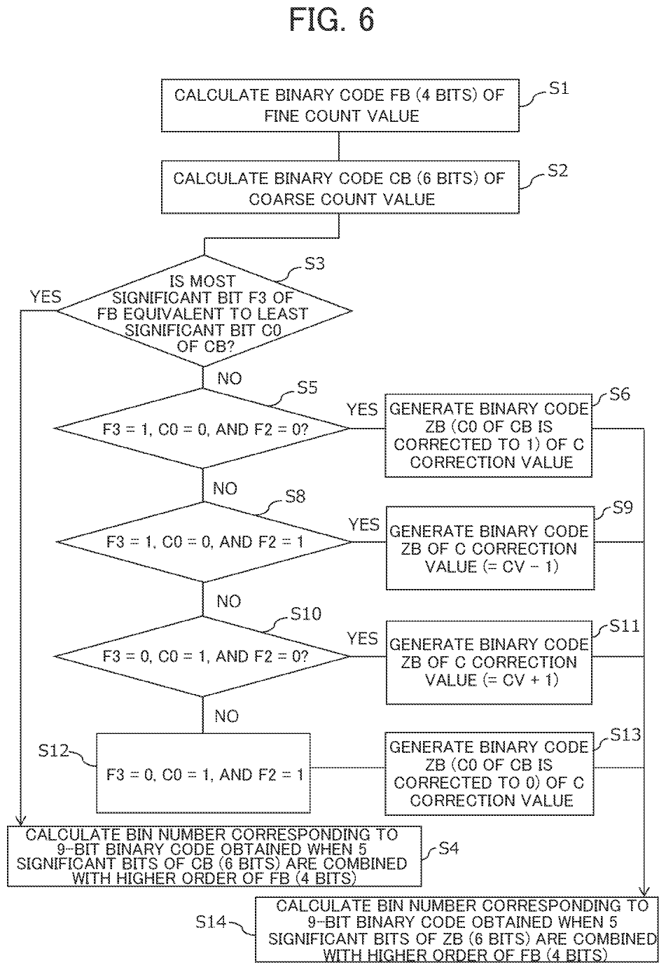

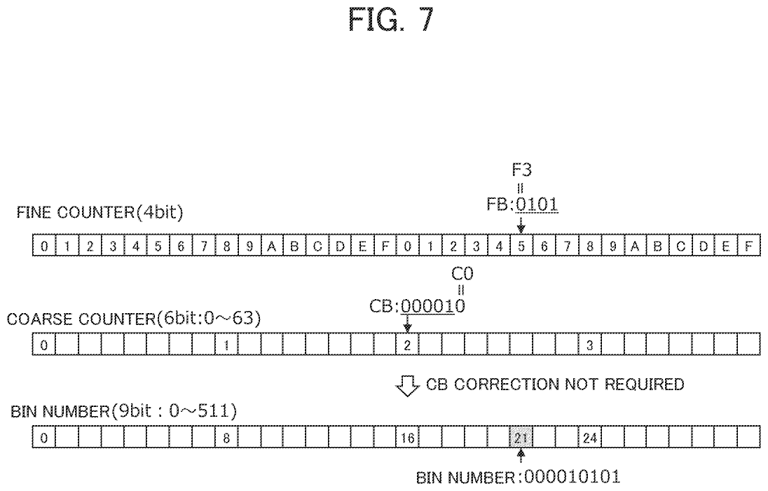

FIG. 6 is a flowchart showing an example of how to calculate a BIN number. FIGS. 7 to 11 are diagrams illustrating an example of how to calculate a BIN number. As illustrated in FIG. 6, at Step S1, a binary code FB (4 bits) of a fine count value is calculated. At Step S2, a binary code CB (6 bits) of a coarse count value is calculated. Step S2 involves determining whether a most significant bit F3 of FB is equivalent to a least significant bit C0 of CB. If YES (equivalent), the processing proceeds to Step S4 to calculate a BIN number corresponding to a 9-bit binary code obtained when 5 significant bits of CB (6 bits) are combined with a higher order of FB (4 bits).

If NO (different) at Step S3, the processing proceeds to Step S5 to determine whether F3=1, C0=0, and F2=0. If YES (equivalent), the processing proceeds to Step S6 to generate a binary code ZB (C0 of CB is corrected to 1) of a coarse correction value (a C correction value). After Step S6, the processing proceeds to Step S14. Step S14 involves calculating a BIN number corresponding to a 9-bit binary code obtained when 5 significant bits of ZB (6 bits) are combined with a higher order of FB (4 bits).

If NO at Step S5, the processing proceeds to Step S8 to determine whether F3=1, C0=0, and F2=1. If YES, the processing proceeds to Step S9 to generate a binary code ZB of a C correction value (=CV−1). If NO at Step S8, the processing proceeds to Step S10 to determine whether F3=0, C0=1, and F2=0. If YES, the processing proceeds to Step S11 to generate a binary code ZB of a C correction value (=CV+1). If NO at Step S10, F3=0, C0=1, and F2=1 (Step S12). The processing proceeds to Step S13 to generate a binary code ZB (C0 of CB is corrected to 0) of a coarse correction value (a C correction value). After Steps S9, S11, and S13, the processing proceeds to Step S14. Step S14 involves calculating a BIN number corresponding to a 9-bit binary code obtained when 5 significant bits of ZB (6 bits) are combined with a higher order of FB (4 bits).

As can be seen, when the fine count value is required to be corrected, if a second most significant bit F2 of the binary code FB of the fine count value is 0, a value obtained by adding 1 to the coarse count value CV is set to the coarse correction value (the C correction value). If the second most significant bit F2 of the binary code FB of the fine count value is 1, a value obtained by subtracting 1 from the coarse count value CV is set to the coarse correction value (the C correction value).

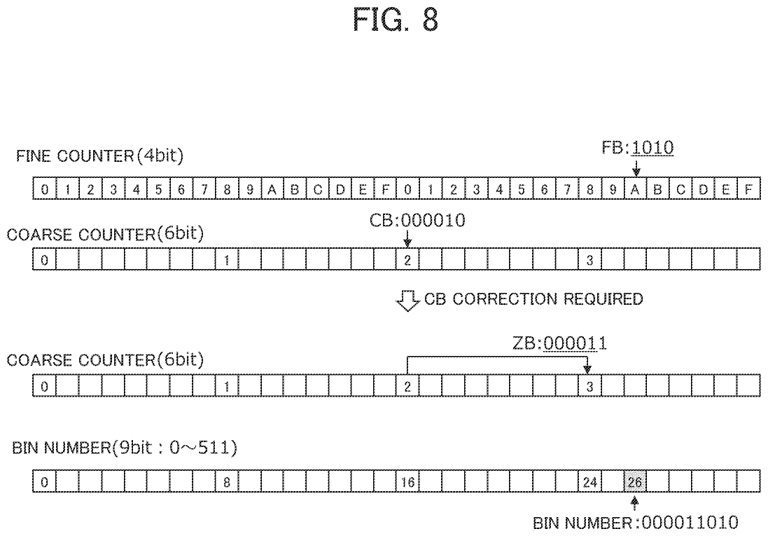

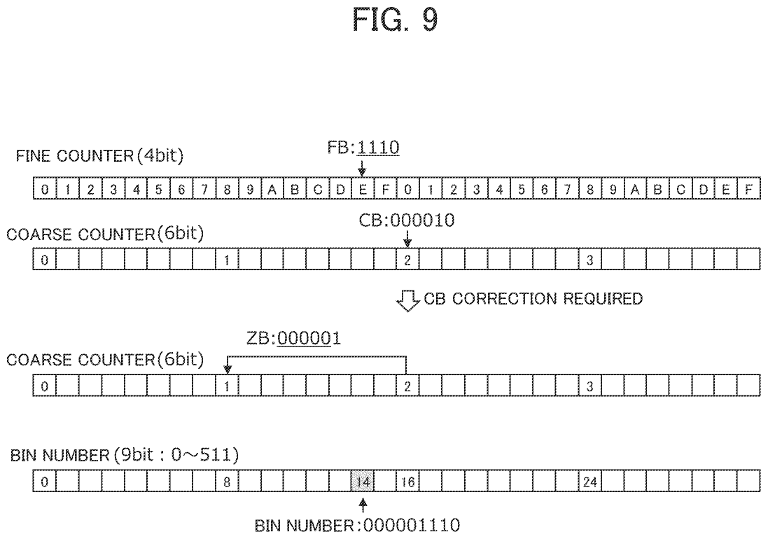

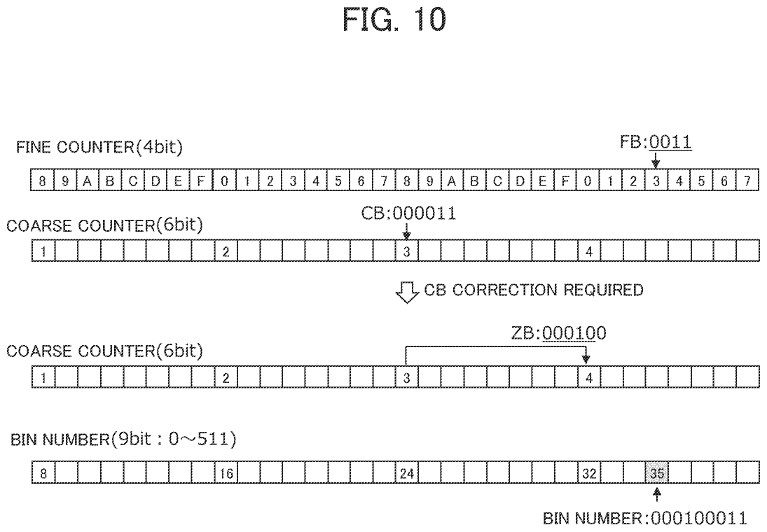

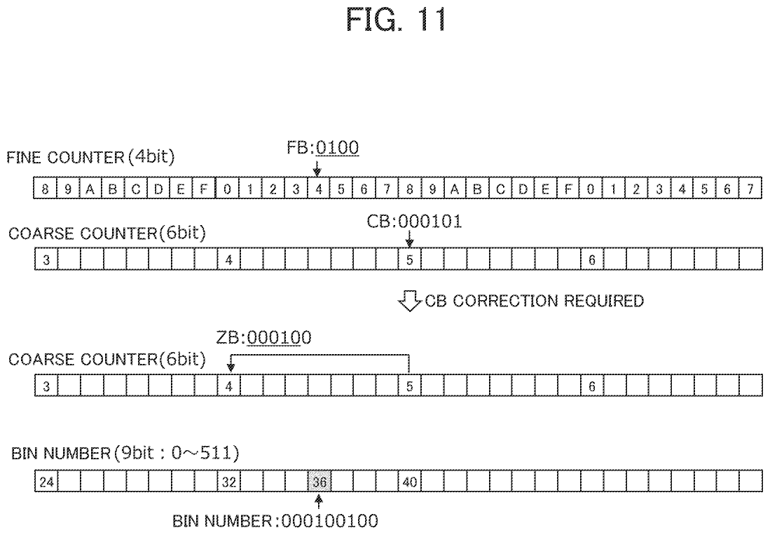

FIG. 7 shows a case where the processing proceeds from Step S3 to Step S4. The fine count value FV is 5. The coarse count value CV is 2. The bin number BIN is 21. FIG. 8 shows a case where the processing proceeds from Step S6 to Step S7. The fine count value FV is A. The coarse count value CV is 2. The coarse correction value CZ (the C correction value) is 3. The bin number BIN is 26. FIG. 9 shows a case where the processing proceeds from Step S9 to Step S14. The fine count value FV is E. The coarse count value CV is 2. The coarse correction value CZ (the C correction value) is 1. The bin number BIN is 14. FIG. 10 shows a case where the processing proceeds from Step S11 to Step S14. The fine count value FV is 3. The coarse count value CV is 3. The coarse correction value CZ (the C correction value) is 4. The bin number BIN is 35. FIG. 11 shows a case where the processing proceeds from Step S13 to Step S14. The fine count value FV is 4. The coarse count value CV is 5. The coarse correction value CZ (the C correction value) is 4. The bin number BIN is 36.

The signal generating circuit 5 may be a ring oscillator, and the ring oscillator may continue to operate longer than a period during which the M fine count values are output. The ring oscillator may continue to operate longer than a period during which the N coarse count values are output.

The time measuring device 30 corrects an error of the coarse count value CV. Such a feature allows the TDC 10 to operate continuously without interruption. If the time measuring device 30 includes a plurality of TDCs 10, the latch circuit has to be simply connected to just one signal generating circuit 5 (e.g., the ring oscillator). Such a feature can reduce the circuit size. If a plurality of TDCs are provided to form multiple channels, one ring oscillator serves as a time reference. Such a feature can reduce time variations between the channels, and also simultaneously output a drive signal of a light-emitting element (e.g., a VCSEL).

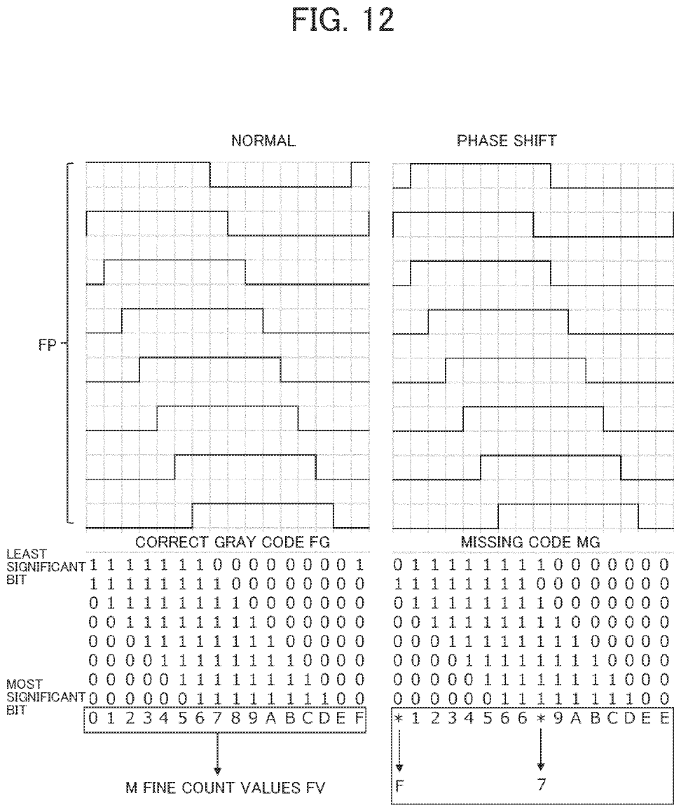

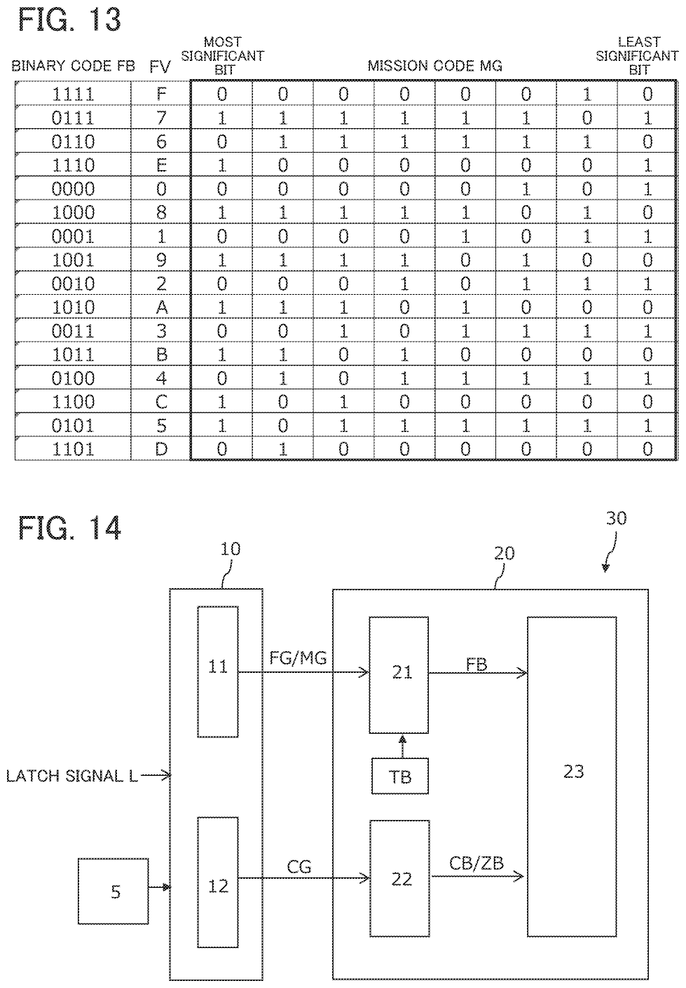

FIG. 12 is a diagram showing correspondence between gray codes and fine count values output from the first counter. FIG. 13 is a table for associating missing (gray) codes with fine count values. FIG. 14 is a block diagram illustrating a configuration of a time measuring device having a table.

As illustrated in FIGS. 12 to 14, if, for example, a phase shift of the first pulse signal FP causes the first counter 11 to output a missing code MG not included in the M gray codes (e.g., 16 gray codes of 0 to 9 and A to F) correctly corresponding to the M fine count values (e.g., 16 fine count values), the first code-converting unit 21 may select a fine count value corresponding to a missing code output from the M fine count values. The control unit 20 may have a table TB (a lookup table LUT) for associating a plurality of missing codes MG with the M fine count values FV, as illustrated in FIGS. 13 and 14. Note that if a phase shift as illustrated in FIG. 12 occurs (if a missing code is generated), neither 0 nor 8 is output as a fine count value FV.

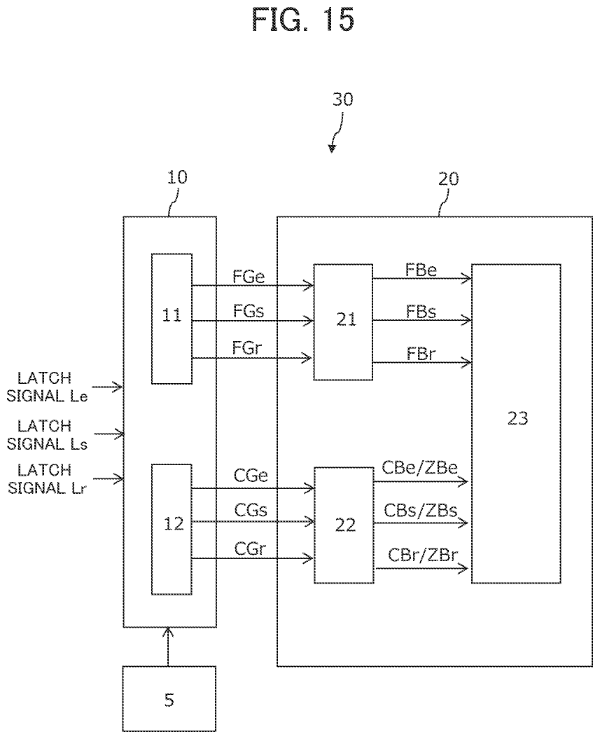

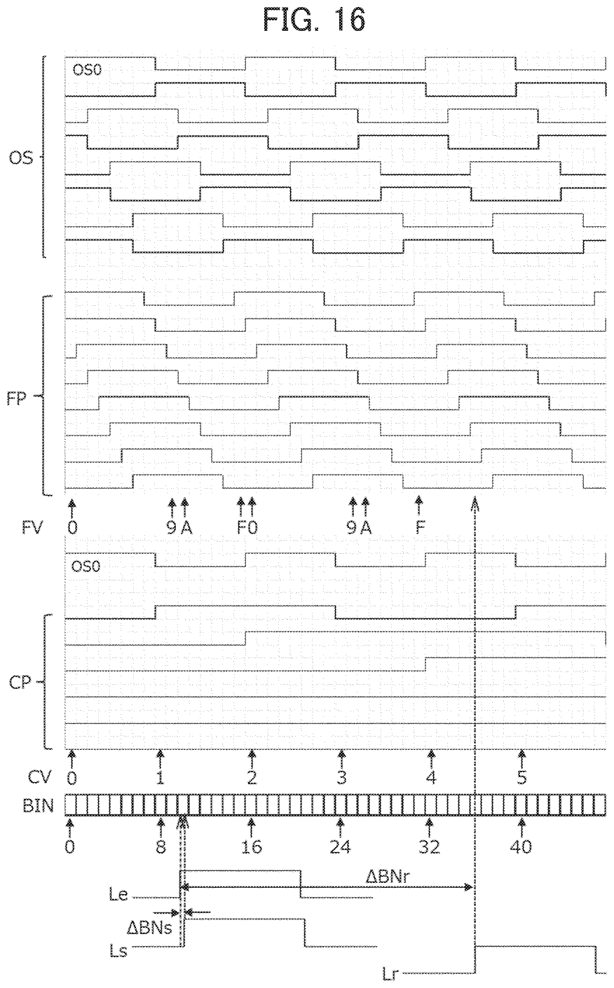

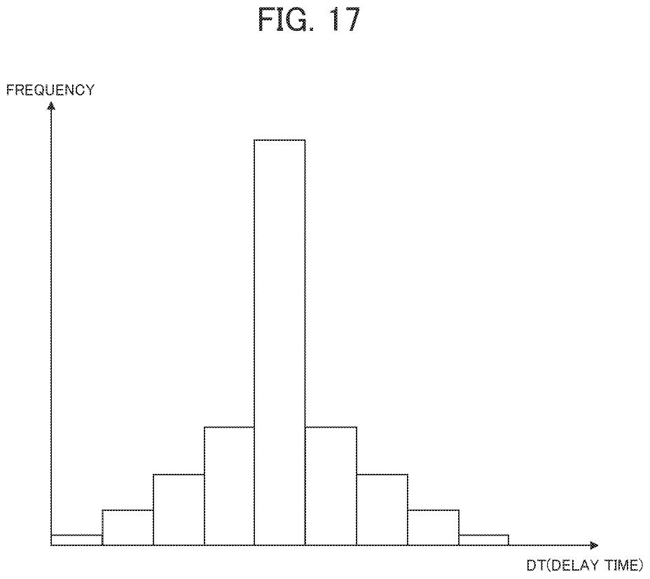

FIG. 15 is a block diagram illustrating a configuration of the time measuring device according to the embodiments. FIG. 16 is a timing diagram showing an operation of the time measuring device according to the embodiments. FIG. 17 is a histogram generated by the time calculating unit. As illustrated in FIGS. 15 and 16, the control unit 20 may perform, once or more, a step of calculating bin numbers BIN each corresponding to one of a latch signal Le (a start latch signal), a latch signal Ls (a reference latch signal), and a latch signal Lr (a return latch signal).

Specifically, the control unit 20 converts a gray code FGe into a binary code FBe, the gray code FGe being of a fine count value latched with a latch signal Le. The control unit 20 converts a gray code CGe into a binary code CBe, and generates, as necessary, a binary code ZBe of a coarse correction value, the gray code CGe being of a coarse count value latched with the latch signal Le. Using the binary code FBe and the binary code CBe/ZBe, the control unit 20 calculates a bin number BIN corresponding to the latch signal Le.

Likewise, the control unit 20 converts a gray code FGs into a binary code FBs, the gray code FGs being of a fine count value latched with a latch signal Ls. The control unit 20 converts a gray code CGs into a binary code CBs, and generates, as necessary, a binary code ZBs of a coarse correction value, the gray code CGs being of a coarse count value latched with the latch signal Ls. Using the binary code FBs and the binary code CBs/ZBs, the control unit 20 calculates a bin number BIN corresponding to the latch signal Ls.

Likewise, the control unit 20 converts a gray code FGr into a binary code FBr, the gray code FGr being of a fine count value latched with a latch signal Lr. The control unit 20 converts a gray code CGr into a binary code CBr, and generates, as necessary, a binary code ZBr of a coarse correction value, the gray code CGr being of a coarse count value latched with the latch signal Lr. Using the binary code FBr and the binary code CBr/ZBr, the control unit 20 calculates a bin number BIN corresponding to the latch signal Lr.

Then, as illustrated in FIG. 16, the time calculating unit 23 calculates: ΔBNs that is a difference between the bin number BIN corresponding to the latch signal Ls and the bin number BIN corresponding to the latch signal Le; ΔBNr that is a difference between the bin number BIN corresponding to the latch signal Lr and the bin number BIN corresponding to the latch signal Le, and a delay time DT obtained by subtracting ΔBNs from ΔBNr. In FIG. 16, the bin number BIN corresponding to the latch signal Ls is 10, the bin number BIN corresponding to the latch signal Le is 10, and the bin number BIN corresponding to the latch signal Lr is 36. Hence, relationships of ΔBNs=0 and ΔBNr=26 hold. One cycle (1.6 ns) of the reference signal OS corresponds to a 16 bin number. Hence, a relationship of ΔBNr=26=2.6 [ns] holds.

When a step of obtaining ΔBNs, ΔBNr, and the delay time DT is carried out multiple times, a histogram can be created as illustrated in FIG. 17. The time calculating unit 23 can output, for example, a delay time DT with the highest frequency in the histogram of FIG. 17 (e.g., a time required for the laser beam to reciprocate between the time measuring device 30 and an object).

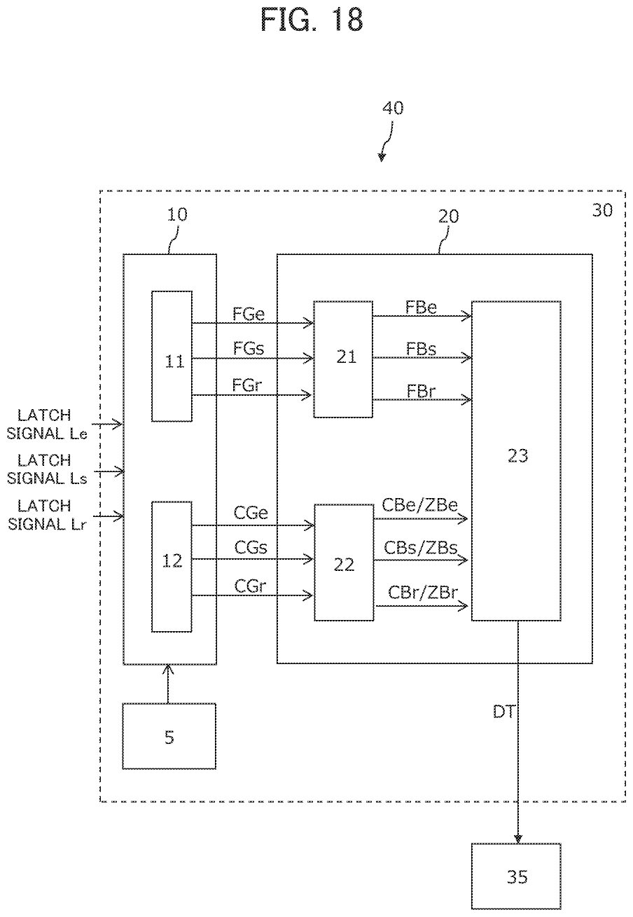

FIG. 18 is a block diagram illustrating a configuration of a distance measuring device according to the embodiments. As illustrated in FIG. 18, a distance measuring device 40 according to the embodiments includes: the time measuring device 30; and a distance calculating unit 35. The distance calculating unit 35 measures a distance to the object, utilizing, for example, the delay time DT output from the time calculating unit 23, and a speed of a laser beam emitted to the object.

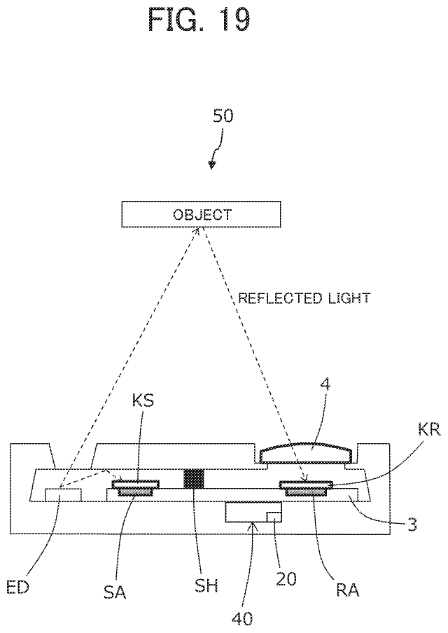

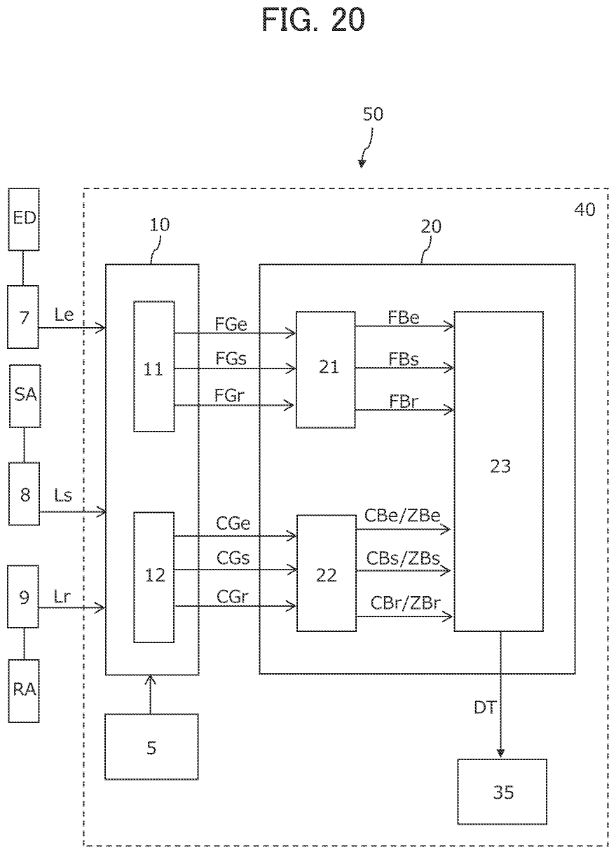

FIG. 19 is a schematic cross-sectional view of a configuration of an optical sensor device according to the embodiments. FIG. 20 is a block diagram illustrating a configuration of the optical sensor device according to the embodiments. As illustrated in FIGS. 19 and 20, an optical sensor device 50 includes: a light-emitting element ED (e.g., a VCSEL); a reference optical filter KS; a return optical filter KR; a condenser lens 4; a light-shielding wall SH; a light receiver IC3 including a reference SPAD array SA and a return SPAD array RA (a light-receiving element); and the distance measuring device 40 (see FIG. 18) connected to the light receiver IC3. The light (e.g., a laser beam) emitted from the light-emitting element ED enters the SPAD array SA through the reference optical filter KS. Simultaneously, the light is reflected off a detection object, and enters the SPAD array RA through the condenser lens 4 and the return optical filter KR.

In the optical sensor device 50, the latch signal Le rises in response to the rise of a drive current in a light-emitting element drive circuit 7, the latch signal Ls rises in response to the rise of a light-receiving current in an array drive circuit 8, and the latch signal Lr rises in response to the rise of a light-receiving current in an array drive circuit 9. The latch signal Le (the start latch signal) is a signal corresponding to the timing at which the light-emitting element ED emits light. The latch signal Ls (the reference latch signal) is a signal corresponding to the timing at which reference light from the light-emitting element is received with the reference SPAD array SA (a reference light-receiving element). The latch signal Lr (the return latch signal) is a signal corresponding to the timing at which the light emitted from the light-emitting element ED and reflected off the object is received with the return SPAD array RA (a return light receiving element). The control unit 20 calculates bin numbers BIN each corresponding to one of the latch signal Le, the latch signal Ls, and the latch signal Lr (corresponding to the rise of one of the latch signals), and calculates: ΔBNs that is a difference between the bin number BIN corresponding to the latch signal Ls and the bin number BIN corresponding to the latch signal Le; ΔBNr that is a difference between the bin number BIN corresponding to the latch signal Lr and the bin number BIN corresponding to the latch signal Le, and a delay time DT obtained by subtracting ΔBNs from ΔBNr. When a step of obtaining ΔBNs, ΔBNr, and the delay time DT is carried out multiple times, a histogram can be created. The time calculating unit 23 can output, for example, a delay time DT with the highest frequency in the histogram (e.g., a time required for the emitted light to reciprocate between the optical sensor device 50 and an object). The distance calculating unit 35 measures a distance to the object, utilizing, for example, the delay time DT output from the time calculating unit 23, and a speed of a laser beam emitted to the object.

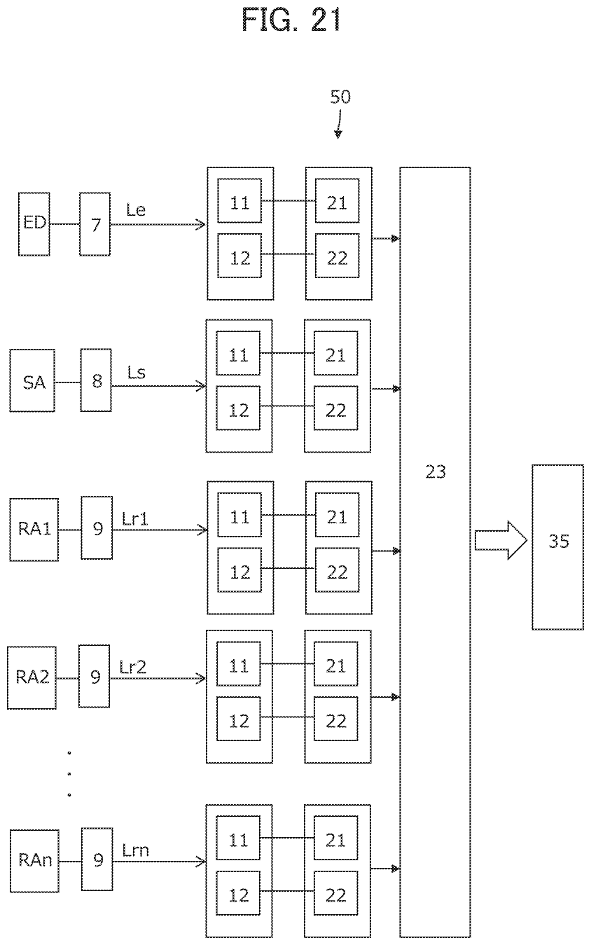

FIG. 21 is a block diagram illustrating a configuration of the optical sensor device according to the embodiments. As illustrated in FIG. 21, the return SPAD array RA may be divided into a plurality of return SPAD arrays RA1 to RAn, and the reflected light from the object may be received with the plurality of SPAD arrays (light-receiving elements) provided in different positions. In FIG. 21, the latch signal Lr1 corresponding to the light received with the return SPAD array RA1 is input to a first counter 11 and a second counter 12, the latch signal Lr2 corresponding to the light received with the return SPAD array RA2 is input to a first counter 11 and a second counter 12, and the latch signal Lrn corresponding to the light received with the return SPAD array RAn is input to a first counter 11 and a second counter 12. The configuration in FIG. 21 makes it possible to find a three dimensional position of the object.

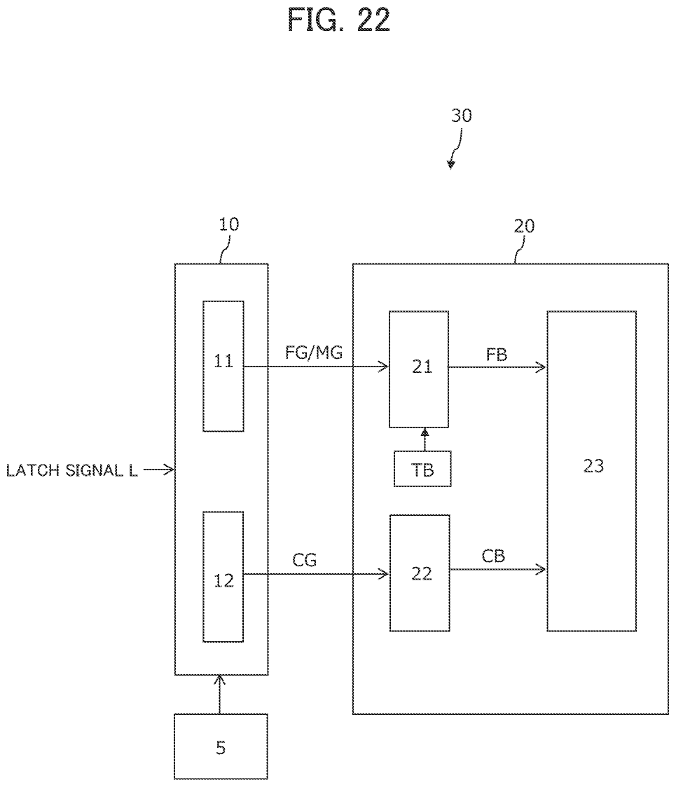

FIG. 22 is a block diagram illustrating a configuration of the time measuring device according to the embodiments. As illustrated in FIGS. 22, 12, and 14, the time measuring device 30 includes: the signal generating circuit 5 that generates a plurality of reference signals in an equivalent cycle with different phases; the first counter 11 that outputs a fine count value FV in a gray code FG, using a plurality of first pulse signals FP obtained from a plurality of reference signals; and the second counter 12 that outputs a coarse count value CV, using a plurality of second pulse signals obtained from the plurality of reference signals and having frequencies lower than frequencies of the plurality of first pulse signals; and the control unit that calculates, if the gray code FG is a missing code MG, a bin number BIN, using the fine count value FV corresponding to the missing code MG and the coarse count value CV.

Where M is a natural number of 2 or more, the first counter 11 periodically outputs M fine count values FV (e.g., 16 fine count values FV of 0 to 9 and A to F). If the first counter 11 outputs the missing code MG not included in M correct gray codes corresponding to the M fine count values, the first code-converting unit 21 selects, from the M fine count values FV, a fine count value FV corresponding to the missing code MG, and converts the selected fine count value FV into a binary code FB. The control unit 20 may have the table TB for associating a plurality of missing codes MG with the M fine count values FV, as illustrated in FIGS. 22 and 13.

The time measuring device 30 described in the embodiments can be used for an electronic device such as a laser distance measuring device.

The embodiments described above are introduced for purposes of illustration and description, and are not intended to be limiting. It is apparent for those skilled in the art that many variations will be available in accordance with these examples and descriptions.

What is claimed is:

1. A time measuring device, comprising:
a signal generating circuit configured to generate a plurality of reference signals in an equivalent cycle with different phases;
a first counter configured to output a fine count value, using a plurality of first pulse signals obtained from the plurality of reference signals;
a second counter configured to output a coarse count value, using a plurality of second pulse signals obtained from the plurality of reference signals and having frequencies lower than frequencies of the plurality of first pulse signals; and
a control unit configured to determine whether to correct the coarse count value in accordance with the fine count value and the coarse count value latched with a latch signal, and, if the coarse count value needs to be corrected, configured to calculate a bin number, using the fine count value and a coarse correction value obtained by correcting the coarse count value.

2. The time measuring device according to claim 1,
wherein a count-up interval of the second counter is longer than a count-up interval of the first counter.

3. The time measuring device according to claim 2,
wherein, where M and N are natural number of M<N,
the first counter periodically outputs M fine count values, and
the second counter periodically outputs N coarse count values.

4. The time measuring device according to claim 3,
wherein the signal generating circuit is a ring oscillator.

5. The time measuring device according to claim 4,
wherein the first counter may detect a phase of the ring oscillator to perform counting, and
the second counter may detect oscillation counts of the ring oscillator to perform counting.

6. The time measuring device according to claim 3,
wherein the first counter outputs the fine count value in a gray code, and
the second counter outputs the coarse count value in a gray code.

7. The time measuring device according to claim 6,
wherein the gray code of the fine count value is greater in bit number than the gray code of the coarse count value.

8. The time measuring device according to claim 3,
wherein if relationships of M=2^{X} and N=2^{Y} hold,
the control unit converts: the fine count value into a binary code having X bits; and the coarse count value into a binary code having Y bits.

9. The time measuring device according to claim 8,
wherein the control unit determines that the coarse count value is not required to be corrected if a most significant bit of the binary code of the fine count value is equivalent to a least significant bit of the binary code of the coarse count value, and that the coarse count value is required to be corrected if the most significant bit of the binary code of the fine count value is different from the least significant bit of the binary code of the coarse count value.

10. The time measuring device according to claim 9,
wherein, when the most significant bit of the binary code of the fine count value is different from the least significant bit of the binary code of the coarse count value, the control unit sets a value adjacent to the coarse count value to the coarse correction value, and matches the least significant bit of the binary code of the coarse count value to the most significant bit of the binary code of the fine count value.

11. The time measuring device according to claim 10,
wherein, if a second most significant bit of the binary code of the fine count value is 0, a value obtained by adding 1 to the coarse count value is set to the coarse correction value, and
wherein, if the second most significant bit of the binary code of the fine count value is 1, a value obtained by subtracting 1 from the coarse count value is set to the coarse correction value.

12. The time measuring device according to claim 9,
wherein, when the coarse count value is not corrected, the control unit combines a higher-order (Y−1) bit of the binary code of the coarse count value with a higher order of the binary code of the fine count value, and calculates a bin number corresponding to a (X+Y−1)-bit binary code obtained by the combination.

13. The time measuring device according to claim 10,
wherein, when the coarse count value is corrected, the control unit combines a higher-order (Y−1) bit of a binary code of the coarse correction value with a higher order of the binary code of the fine count value, and calculates a bin number corresponding to a (X+Y−1)-bit binary code obtained by the combination.

14. The time measuring device according to claim 6,
wherein if the first counter outputs a missing code not included in M gray codes corresponding to the M fine count values, the control unit selects, from the M fine count values, a fine count value corresponding to the missing code.

15. The time measuring device according to claim 14,
wherein the control unit has a table for associating a plurality of missing codes with the M fine count values.

16. The time measuring device according to claim 3,
wherein a count interval of the first counter is 1/M of a cycle of the plurality of reference signals.

17. The time measuring device according to claim 16,
wherein the count interval is 1.0 (nanosecond) or less.

18. A time measuring device, comprising:
a signal generating circuit configured to generate a plurality of reference signals in an equivalent cycle with different phases;
a first counter configured to output a fine count value in a gray code, using a plurality of first pulse signals obtained from the plurality of reference signals;
a second counter configured to output a coarse count value, using a plurality of second pulse signals obtained from the plurality of reference signals and having frequencies lower than frequencies of the plurality of first pulse signals; and
a control unit configured to calculate, if the gray code is a missing code, a bin number, using the fine count value corresponding to the missing code and the coarse count value.

19. The time measuring device according to claim 18,
wherein, where M is natural number of 2 or more,
the first counter periodically outputs M fine count values, and
if the first counter outputs the missing code not included in M gray codes corresponding to the M fine count values, the control unit selects, from the M fine count values, a fine count value corresponding to the missing code.

20. The time measuring device according to claim 19,
wherein the control unit has a table for associating the missing code with the fine count value.
